(19) United States
(12) Patent Application Publication
(10) Pub. No.: US 2010/0054743 A1
(43) Pub. Date: Mar. 4, 2010

(54) METHOD AND DEVICE FOR DIGITISING AN ELECTRICAL SIGNAL

(76) Inventor: John Heaton, Worcestershire (GB)

Correspondence Address: HOWARD & HOWARD ATTORNEYS PLLC, 450 West Fourth Street, Royal Oak, MI, 48067, US

(21) Appl. No.: 12/095,535

(22) PCT Filed: Nov. 28, 2006
(86) PCT No.: PCT/GB06/04450

§ 371 Date: Nov. 16, 2009

(30) Foreign Application Priority Data
Dec. 1, 2005 (GB) 0524461.1

(51) Int. Cl. H04J 14/02

(52) U.S. Cl. 398/91

(57) ABSTRACT

A device for digitising an electrical signal comprising (A) at least two continuous wave lasers each being adapted to produce light at a different wavelength; (B) a dispersive optical chopper adapted to chop the output of each of the lasers into optical pulse trains, introduce a predetermined delay between each of the optical pulse trains and to combine the optical pulse trains into a single optical path; (C) a modulator having an input port adapted to receive the output of the dispersive optical chopper, an output port and at least one optical path extending therebetween, the modulator being adapted to receive a microwave signal and to modulate the amplitude of the optical signal in the optical path in response to the microwave signal; (D) an optical splitter for splitting the signal received from the output port of the modulator into a plurality of wavelength dependent signal paths; and (E) a plurality of analogue to digital converters each connected at least one wavelength dependent signal path for converting the received optical signal to a digital signal.

The present invention relates to a method and device for digitising an electrical signal, preferably a microwave signal. More particularly, but not exclusively, the present invention relates to a method of digitising a microwave signal comprising the steps of providing a plurality of laser pulse trains of different wavelengths, introducing a time delay between each of the pulse trains, passing each of the pulse trains through a modulator where they are modulated by an optical microwave signal, splitting the modulated signals into a plurality of wavelength dependent paths and digitising the received signal in each path. The present invention also relates to a device for performing such a method.

Devices for digitising microwave signals are known. Such devices use either time division multiplexing (TDM) or wavelength division multiplexing (WDM). TDM systems provide a succession of optical pulses. These are modulated by the microwave signal. A high speed RF driven optical switching element sends successive pulses along different optical paths. An analogue to digital converter in each path digitises the received pulses. The high speed optical element is difficult and expensive to manufacture and is also difficult to drive electrically.

WDM systems provide a series of pulses of different wavelengths. These are modulated by the microwave signal before being split into different optical paths by an arrayed waveguide grating before being digitised. It is difficult to generate a series of pulses with different wavelengths from one pulse to the next. Such WDM systems are complex and difficult to manufacture.

Accordingly, a first aspect of the invention provides a device for digitising an electrical signal comprising
(A) at least two continuous wave lasers each being adapted to produce light at a different wavelength;
(B) a dispersive optical chopper adapted to chop the output of each of the lasers into optical pulse trains, introduce a predetermined delay between each of the optical pulse trains and to combine the pulse trains into a single optical path;
(C) a modulator having an input port adapted to receive the output of the dispersive optical chopper, an output port and at least one optical path extending therebetween, the modulator being adapted to receive a microwave signal and to modulate the amplitude of the optical signal in the optical path in response to the microwave signal;
(D) an optical splitter for splitting the signal received from the output port of the modulator into a plurality of wavelength dependent signal paths; and
(E) a plurality of analogue to digital converters each connected to at least one wavelength dependent signal path for converting the received optical signal to a digital signal.

Using this approach to make a photonic analogue to digital converter (ADC) enables sampling and digitisation of arbitrary electronic, preferably microwave signals to be achieved at significantly higher sampling rates and microwave signal bandwidths than can be achieved with purely electronic ADCs.

The use of continuous wave lasers allows the device to sample signals with higher precision than other wavelength division multiplexed architectures. Other WDM systems require a short pulsed (mode locked) laser which may not have a stable enough pulse to pulse power jitter to give a high enough effective number of bits (ENOB) or spurious free dynamic range (SFDR).

In addition the device according to the invention allows a complex sampling function to be achieved using simple passive photonic components. The device according to the invention is reliable and lightweight and is particularly suitable for use in high performance avionic and naval electronic warfare applications. Other applications include high speed single shot oscilloscopes and spectrum analysers.

Preferably the dispersive optical chopper comprises an optical combiner having a plurality of input ports each adapted to receive the output of a laser and an output port, the optical combiner being adapted to combine the optical signals received at the plurality of input ports at the output port.

Preferably, the dispersive optical chopper comprises at least one optical pulse generator adapted to receive continuous optical signals at one or more wavelengths and to convert these to one or more optical pulse trains at these wavelengths.

The pulse generator can be adapted to receive the output of the optical combiner.

The device can further comprise a dispersive optical element connected between the pulse generator and the port of the optical modulator to introduce a wavelength dependent delay between optical pulse trains received from the optical pulse generator.

The device can comprise a plurality of optical pulse generators, one being connected between each of the lasers and a corresponding input port of the optical combiner.

The device can comprise a dispersive optical element connected between the output of the optical combiner and the modulator.

Alternatively, the device can comprise a plurality of delay elements, one being connected between each optical pulse generator and the corresponding input of the optical combiner, each delay element being adapted to introduce a predetermined delay in the optical signal passing through the delay element.

The dispersive optical element can comprise an optical fibre, preferably a fibre optic cable.

The dispersive optical element can be a fibre bragg grating.

The dispersive optical element can be an echelle grating.

The dispersive optical element can comprise
(i) a second optical splitter adapted to split received optical pulse trains into a plurality of wavelength dependent paths;
(ii) a second optical combiner adapted to receive optical signals at a plurality of input ports and combine them at an output port, and
(iii) a plurality of delay elements, each delay element being connected between an output of the second optical splitter and a corresponding input of the second optical combiner.

The delay element can comprise an optical fibre, preferably a fibre optic cable.

The at least one optical splitter can be an arrayed waveguide grating.

The at least one optical splitter can be a thin film filter.

The at least one optical splitter can be a planar waveguide echelle grating.

The at least one optical combiner can be an arrayed waveguide grating.

The at least one optical combiner can be a thin film filter.

The at least one optical combiner can be a planar waveguide echelle grating.

In a further aspect of the invention there is provided

a method of digitising an electrical signal comprising the steps of
(A) providing a plurality of continuous wave lasers, each providing a continuous optical wave at a different wavelength;
(B) converting the continuous optical waves into a plurality of optical pulse trains at different wavelengths;
(C) introducing a time delay between each of the optical pulse trains;
(D) passing each of the optical pulse trains through an optical modulator where it is modulated by a received microwave signal;
(E) splitting the modulated optical pulse trains into a plurality of wavelength dependent paths; and,
(F) converting each of the modulated optical pulse trains into a digital signal.

The output of the plurality of lasers can be combined into a single path before modulation.

The combination can be performed by an arrayed waveguide grating.

Alternatively, the combination can be performed by a thin film filter.

The combination can be performed by an echelle grating.

Preferably, each of the outputs is converted to an optical pulse train before combination.

The predetermined time delay can be introduced between the optical pulse trains before combination.

The time delay can be introduced by passing the optical pulse trains through at least one dispersive optical element, preferably an optical fibre, more preferably a fibre optic cable

The dispersive optical element can be an echelle grating or fibre Bragg grating.

Each of the outputs of the plurality of lasers can be converted to a optical pulse train after combination.

A predetermined delay can be introduced between the optical pulse trans after combination.

The present invention will now be described by way of example only and not in any limitative sense with reference to the accompanying drawings in which

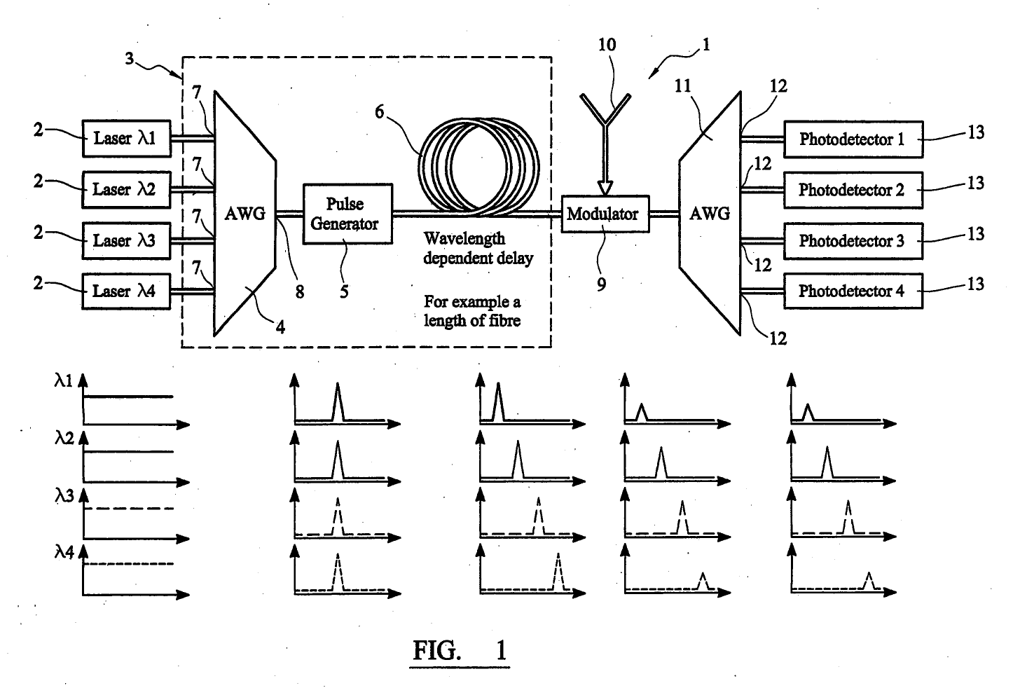

FIG. 1 shows a first embodiment of a device according to the invention;

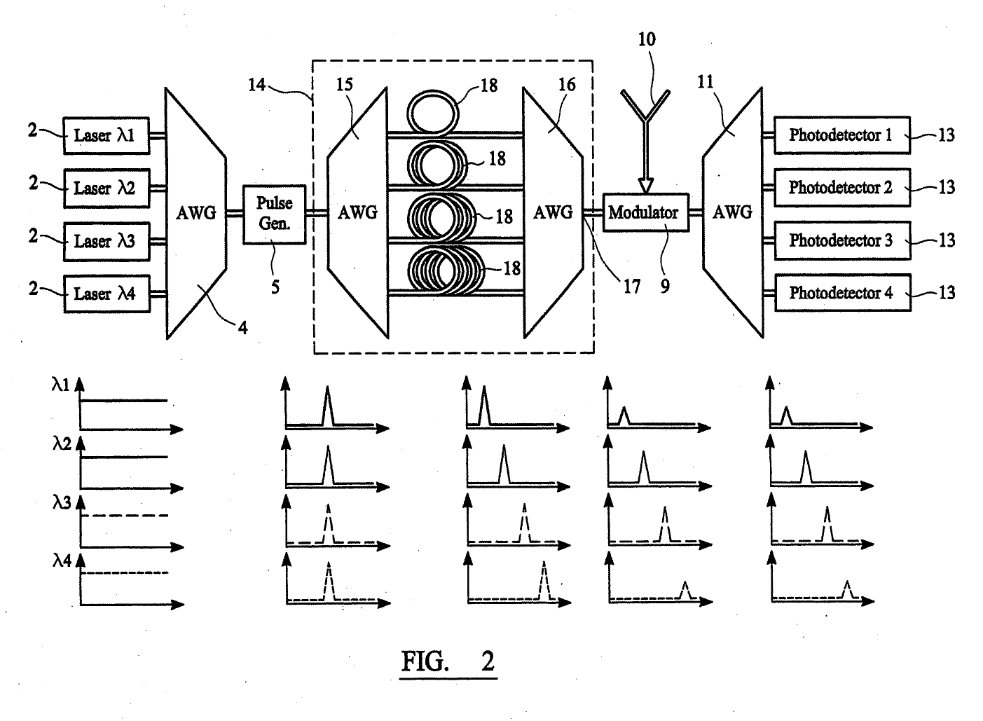

FIG. 2 shows a second embodiment of a device according to the invention;

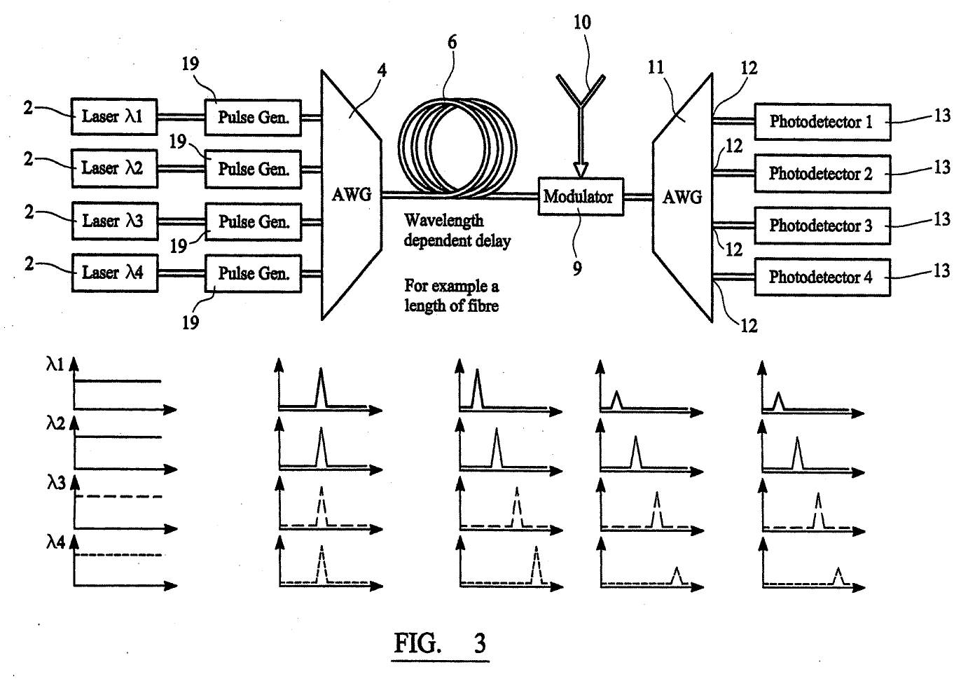

FIG. 3 shows a third embodiment of a device according to the invention;

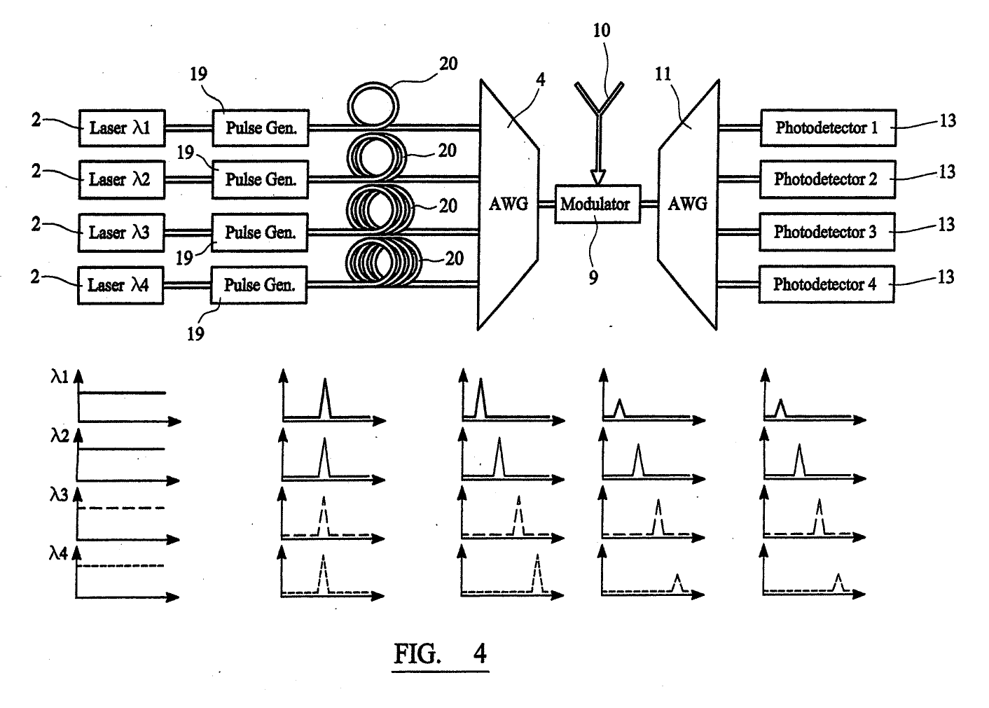

FIG. 4 shows a fourth embodiment of a device according to the invention;

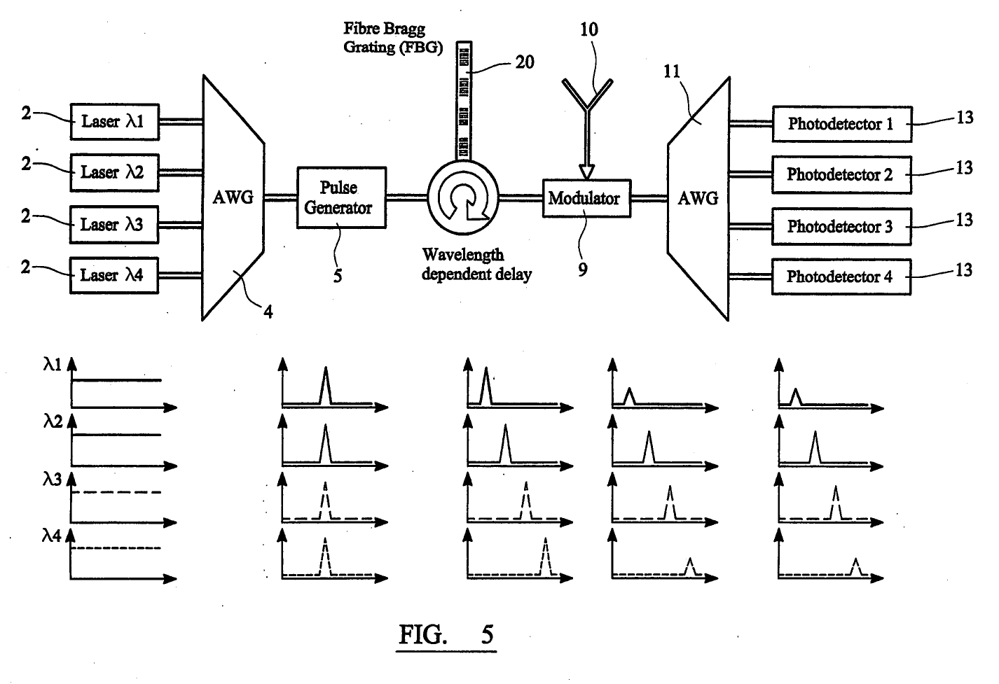

FIG. 5 shows a fifth embodiment of a device according to the invention;

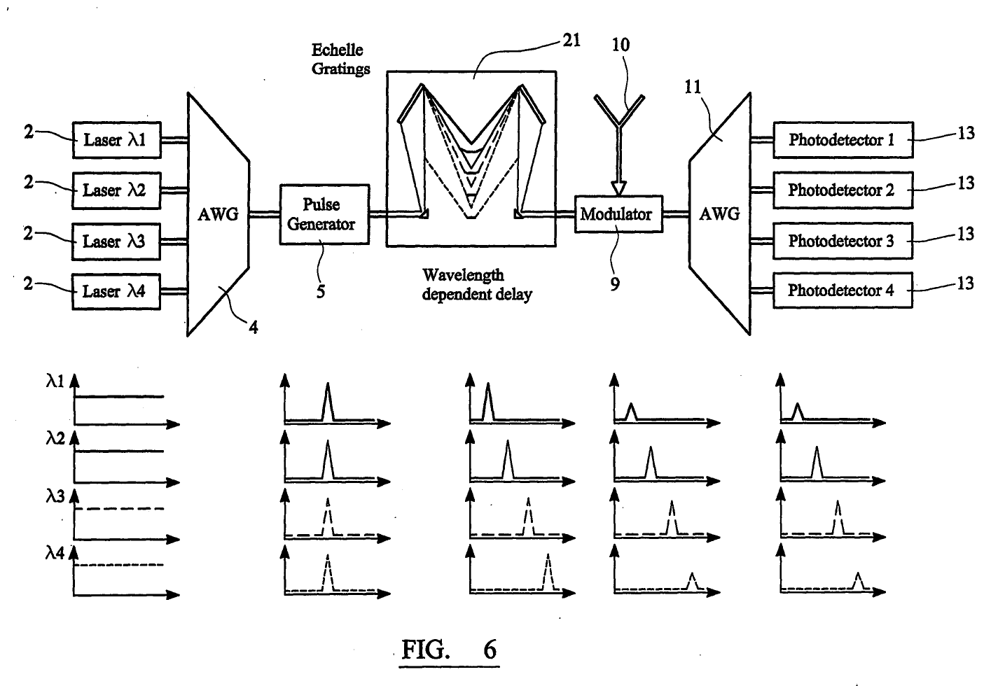

FIG. 6 shows a sixth embodiment of a device according to the invention;

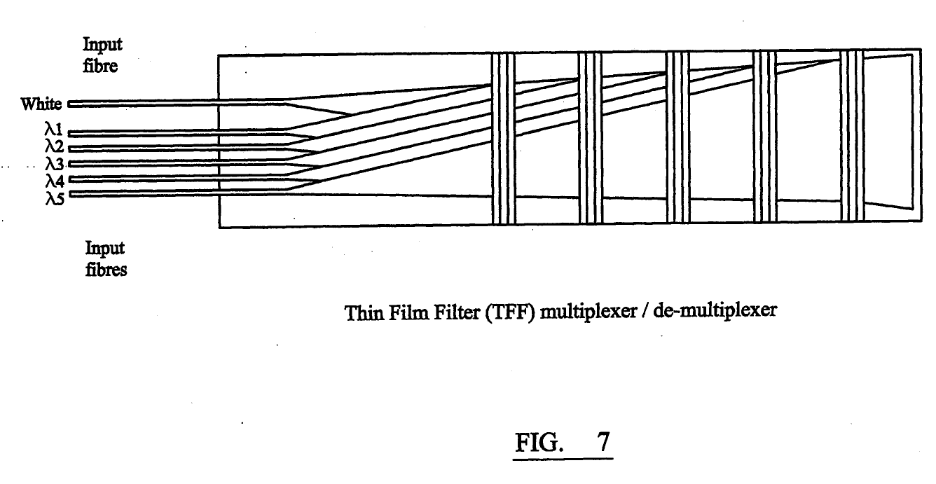

FIG. 7 shows a thin film filter multiplexer/demultiplexer; and

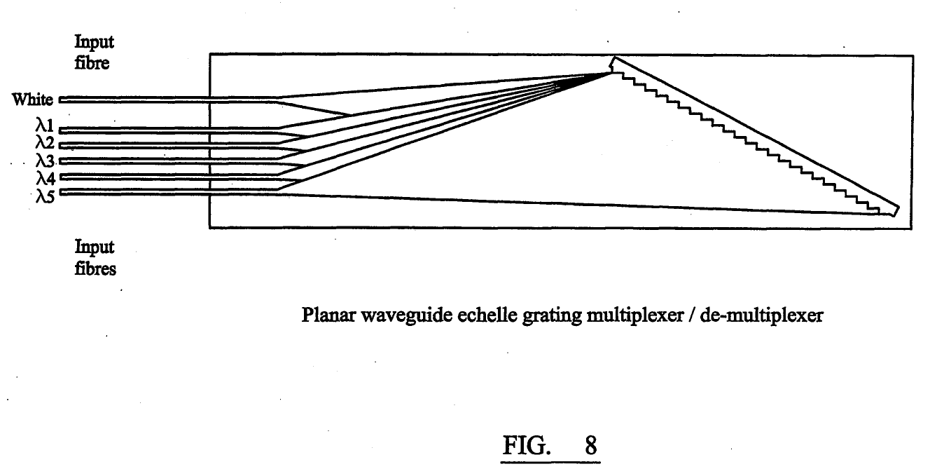

FIG. 8 shows a planar waveguide echelle grating multiplexer/demultiplexer.

Shown in FIG. 1 is a device for digitising a microwave signal according to the invention. The device 1 comprises a plurality of continuous wave (CW) lasers 2 each having a different wavelength from the others. The output from each of the continuous wave lasers 2 is received by a dispersive optical chopper 3. The dispersive optical chopper 3 comprises an arrayed waveguide grating (AWG) 4, a pulse generator 5 and a dispersive optical element 6, the function of each of which is described below. The AWG 4 comprises a plurality of input ports 7, each of which is adapted to receive the output of a corresponding CW laser 2. The AWG 4 combines the signal received at the plurality of input ports 7 at a single output port 8.

Connected to the output port 8 of the AWG 4 is the pulse generator 5. The pulse generator 5 receives the continuous wave output of the AWG 4 at a plurality of wavelengths and converts these into optical pulse trains at the same wavelengths. The optical pulse trains may be several wavelengths long. Typically the pulse is less than 1 ns but longer than ifs. The pulse generator of the embodiment is a stable low jitter electro-refractive pulse generator.

Extending from the output of the pulse generator 5 is the dispersive optical element 6 comprising fibre optic cable 6. A dispersive fibre optic cable 6 is one where the speed of light through the cable varies with the wavelength of the light. The dispersive fibre optic cable 6 introduces a very accurately known timing separation between the different wavelength optical pulse trains as they exit the fibre optic cable 6.

The dispersed optical pulse trains are received by a modulator 9. As the optical pulse trains pass through the modulator 9 they are modulated by a received analogue microwave signal 10. The amplitude of the signal output from the modulator 9 depends upon the amplitude of the microwave signal. The operation of such modulators 9 is well known and will not be described further.

The output from the modulator 9 is received by an optical splitter 11 comprising an AWG 11. The AWG 11 splits the modulator output into a plurality of wavelength dependent optical paths 12. Each of the optical paths 12 receives the optical pulse train from one of the CW lasers 2.

A plurality of photodetectors 13 are connected one to each of the outputs 12 of the AWG splitter 11. Filters (not shown) are connected to the outputs of the photodetectors 13 to broaden the received optical pulses which are in turn read by electronic analogue to digital converters (ADCs) (not shown).

The device according to the invention has the advantage that the microwave signal can be sampled at very short time intervals—the time between the different wavelength optical pulse trains as they leave the optical fibre 6. The analogue to digital converter however need only digitise the received signals at the rate the pulse generator 5 generates optical pulse trains

Shown in FIG. 2 is a second embodiment of a device according to the invention. The device of FIG. 2 is similar to that of FIG. 1 except the dispersive fibre optic cable 6 is replaced by a more complex dispersive optical element 14. The dispersive optical element 14 of FIG. 2 comprises a second AWG splitter 15 which splits the optical pulse trains received from the pulse generator 5 into a plurality of wavelength dependent paths. The dispersive optical element also comprises an AWG optical combiner 16 which combines the optical pulse trains at a plurality of input ports at a single output port 17. The output port 17 is connected to the input of the modulator 9. Extending between each of the outputs of the second optical splitter 15 and a corresponding input of the AWG combiner 16 is a delay element 18 which in this embodiment comprises an optical fibre 18. Each of the optical fibres 18 introduces a different delay to the optical pulse train passing along it. Hence, when the optical pulse trains are combined there is a controlled time delay between each of them.

The embodiment of FIG. 2 has the advantage that each optical pulse train passes along a different dispersive optical fibre 18 according to its wavelength. One therefore has a greater degree of control over the time delay between the optical pulse trains as they are received by the modulator 9. By altering the length of one of these fibres 18 one can alter the delay of an optical pulse train of one particular wavelength without affecting the delay of the other optical pulse trains.

Shown in FIG. 3 is a third embodiment of a device according to the invention. This embodiment is similar to that of FIG. 1 except the single pulse generator 5 is replaced by a plurality of pulse generators 19, each one connected between a CW laser 2 and a corresponding input port of the AWG optical combiner 4. The method of operation of this device is similar to the device of FIG. 1 except each pulse generator 5 produces an optical pulse train before the AWG optical combiner 4. The combiner 4 then combines these optical pulse trains before they are passed to the dispersive fibre optic cable 6.

This embodiment has the advantage that different pulse generators 19 can be driven at different clock rates for recovering the original frequency in under-sampled analogue microwave signals.

Shown in FIG. 4 is a fourth embodiment of a device according to the invention. This device is similar to the device of FIG. 3 except the single dispersive optical element 6 after the AWG combiner 4 is replaced by a plurality of delay elements 20 before the combiner 14. In this embodiment the delay element 20 is an optical fibre 20. Each optical fibre 20 is connected between further pulse generators 19 and the corresponding input port of the AWG optical combiner 4. In use each pulse generator 19 produces an optical pulse train of the wavelength of its corresponding CW laser 2. Each optical pulse train then passes through the corresponding optical fibre 20 introducing delays between the optical pulse trains These optical pulse trains are then combined by the AWG optical combiner 4 before being passed to the optical modulator 9. Again, each pulse generator 19 can be clocked at a different clock frequency if required. Also, the delay experienced by each optical pulse train may be adjusted individually without affecting the other optical pulse trains by adjusting the length of the optical fibre 20 through which it passes.

The embodiments of FIGS. 2 and 4 have a further advantage. Optical pulse trains of only one wavelength pass through each of the optical fibres 18, 20. One may therefore choose each fibre 18, 20 such that each fibre 18, 20 has ideal properties at the wavelength of the optical pulse train passing through it. Each fibre 18, 20 may be of a different composition if required.

In a further embodiment of the invention (not shown) at least one of the ADCs is connected to a plurality of photodetectors each connected to an output from the final optical splitter. This increases the rate at which the ADCs must digitise the received optical signals but reduces the number of ADCs required.

Shown in FIG. 5 is a fifth embodiment of a device according to the invention. This embodiment is similar to that of FIG. 1 except the dispersive optical element comprises a fibre Bragg grating 20. The operation of such a grating 20 is well known and will not be discussed further.

Shown in FIG. 6 is a sixth embodiment of a device according to the invention. Again, this device is similar to that of FIG. 1 except the dispersive optical element is a echelle grating 21.

The devices of FIGS. 1 to 6 all include Arrayed Waveguide Gratings as optical splitters and combiners. Other optical devices are possible. Shown in FIGS. 7 and 8 are a thin film filter multiplexer/demultiplexer and a planar waveguide echelle grating multiplexer/demultiplexer. The operation of such devices is well known. A prism may also be used as a splitter or combiner.

1. A device for digitising an electrical signal comprising:
(A) at least two continuous wave lasers each being adapted to produce light at a different wavelength;
(B) a dispersive optical chopper adapted to chop an output of each of the lasers into pulse trains, introduce a predetermined delay between each of the pulse trains and to combine the pulse trains into a single optical path;
(C) a modulator having an input port adapted to receive the output path of the dispersive optical chopper, an output port and at least one optical path extending therebetween, the modulator being adapted to receive a microwave signal and to modulate an amplitude of the optical signal in the optical path in response to the microwave signal;
(D) an optical splitter for splitting the signal received from the output port of the modulator into a plurality of wavelength dependent signal paths; and
(E) a plurality of analogue to digital converters each connected to at least one wavelength dependent signal path for converting the received optical signal to a digital signal.

2. A device as claimed in claim 1, wherein the dispersive optical chopper comprises an optical combiner having a plurality of input ports each adapted to receive the output of a laser and an output port wherein the optical combiner is adapted to combine the optical signals received at the plurality of input ports at the output port.

3. A device as claimed in claim 2, wherein the dispersive optical chopper comprises at least one pulse generator adapted to receive continuous optical signals at one or more wavelengths and to convert the optical signals to one or more optical pulse trains at the one or more wavelengths.

4. A device as claimed in claim 35, wherein the optical pulse generator is adapted to receive the output of the optical combiner.

5. A device as claimed in claim 4 wherein the dispersive optical element is connected between the optical pulse generator and the output port of the optical modulator to introduce a wavelength dependent delay between optical pulse trains received from the optical pulse generator.

6. A device as claimed in claim 35, comprising a plurality of optical pulse generators, one being connected between each of the lasers and a corresponding input port of the optical combiner.

7. A device as claimed in claim 6 wherein the dispersive optical element is connected between the output of the optical combiner and the modulator.

8. A device as claimed in claim 6, comprising a plurality of delay elements, one being connected between each optical pulse generator and the corresponding input of the optical combiner, each delay element being adapted to introduce a predetermined delay in the optical signal passing through the delay element.

9. A device as claimed in claim 35 wherein the dispersive optical element comprises an optical fibre.

10. A device as claimed in claim 35 wherein the dispersive optical element is a fibre Bragg grating.

11. A device as claimed in claim 35 wherein the dispersive optical element is an echelle grating.

12. A device as claimed in claim 35 wherein the dispersive optical element comprises
(i) a second optical splitter adapted to split received optical pulse trains into a plurality of wavelength dependent paths;
(ii) a second optical combiner adapted to receive optical signals at a plurality of input ports and combine them at an output port, and
(iii) a plurality of delay elements, each delay element being connected between an output of the second optical splitter and a corresponding input of the second optical combiner.

13. A device as claimed in claim 12, wherein the delay element comprises an optical fibre.

14. A device as claimed in claim 12 wherein at least one optical splitter is an arrayed waveguide grating.

15. A device as claimed in claim 12 wherein at least one optical splitter is a thin film filter.

16. A device as claimed in claim 12 wherein at least one optical splitter is a planar waveguide echelle grating.

17. A device as claimed in claim 12 wherein at least one optical combiner is an arrayed waveguide grating.

18. A device as claimed in claim 12 wherein at least one optical combiner is a thin film filter.

19. A device as claimed in claim 12 wherein at least one optical combiner is a planar waveguide echelle grating.

20. A method of digitising an electrical signal comprising the steps of
(A) providing a plurality of continuous wave lasers, each providing a continuous optical wave at a different wavelength;
(B) converting the continuous optical waves into a plurality of optical pulse trains at different wavelengths;
(C) introducing a time delay between each of the optical pulse trains;
(D) passing each of the optical pulse trains through an optical modulator wherein each of the optical pulse trains are modulated by a received microwave signal;
(E) splitting the modulated optical pulse trains into a plurality of wavelength dependent paths; and
(F) converting each of the modulated optical pulse trains into a digital signal.

21. A method as claimed in claim 20, wherein the output of the plurality of lasers is combined into a single path before modulating.

22. A method as claimed in claim 21, wherein the combination of the outputs of the plurality of lasers is performed by an arrayed waveguide grating.

23. A method as claimed in claim 21, wherein the combination of the outputs of the plurality of lasers is performed by a thin film filter.

24. A method as claimed in claim 21, wherein the combination of the outputs of the plurality of lasers is performed by an echelle grating.

25. A method as claimed in claim 21, wherein each of the outputs of the plurality of lasers is converted to an optical train before combination.

26. A method as claimed in claim 25, wherein the predetermined time delay is introduced between the optical train before combination of the outputs of the plurality of lasers.

27. A method as claimed in claim 26, wherein the time delay is introduced by passing the optical train through at least one dispersive optical element.

28. A method as claimed in claim 27, wherein the dispersive optical element is an echelle grating.

29. A method as claimed in claim 21, wherein each of the outputs of the plurality of lasers is converted to a optical pulse train after combination.

30. A method as claimed in claim 29, where a predetermined delay is introduced between the optical pulse trains after combination of the outputs of the plurality of lasers.

31-34. (canceled)

35. A device as claimed in claim 3 further comprising a dispersive optical element.

36. A device as claimed in claim 9 wherein the dispersive optical element includes a fibre optic cable.

37. A device as claimed in claim 13 wherein the delay element includes a fibre optic cable.

38. A method as claimed in claim 27 wherein the at least one dispersive optical element includes an optical fibre.

39. A method as set forth in claim 27 wherein the at least one dispersive optical element includes a fibre optic cable.

40. A method as set forth in claim 28 wherein the dispersive optical element is a fibre Bragg grating.
